(19) United States
(12) Patent Application Publication
(10) Pub. No.: US 2008/0255843 A1
(43) Pub. Date: Oct. 16, 2008

(54) Voice recognition system and method

(75) Inventors: Yu-Chen Sun, Keelung City (TW); Chang-Hung Lee, Dounan Township (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/081,080

(22) Filed: Apr. 10, 2008

(30) Foreign Application Priority Data
Apr. 13, 2007 (TW) 09611355

(51) Int. Cl. G10L 15/00

(52) U.S. Cl. 704/250; 704/E15.001

(57) ABSTRACT

The invention provides a method of voice recognition, and the method includes the steps of: obtaining a current position information, obtaining a current voice model according to the current position information; and performing voice recognition according to the current voice model. Particularly, the current position information can be obtained according to network address information, or by a global positioning system.

### BACKGROUND OF THE INVENTION

1. Field of the Invention

The invention relates to a voice recognition system and method, and more particularly, to a voice recognition system and method for selecting a suitable voice model according to the position located.

2. Description of the Prior Art

With the progress of science, the electronic device/system formerly controlled or operated through input apparatus, such as a bottom, a keyboard, or a mouse, is gradually capable of being controlled or operated by voice now.

For example, with the voice controlling mechanism of a mobile phone, after a user presets a phone number and prerecords a corresponding controlling voice, the user needs to send the controlling voice only, instead of operating with keys to dial the phone number every time. Especially when the user needs to make a phone call while focusing on something else, such as driving, the user does not need to dial with his hand through the above-mentioned mechanism, which ensures the safety of driving.

The current voice recognition technology can be divided into the two types of user-dependent and user-independent. The former needs the user to train the voice recognition apparatus before using to achieve best performance; the latter aims not at serving a specific user only and can receive voice orders from different users.

Therefore, the operation of the user-dependent type can mainly be divided into two parts: a training phase and a recognizing phase. In the training phase, the voice recognition apparatus prompts the user to speak each character or phrase of several example vocabularies stored in the apparatus at least one time, so the apparatus can learn the characteristics of the user's voice through the characters or phrases spoken by the user. The example vocabularies of the above-mentioned function can comprise, for example: the numbers on the keyboard; the operational keywords such as dial, transmit, delete, cancel, yes, no, and so on; as well as the names of the dialing targets corresponding to the specific phone numbers. In the recognition phase, the user can operate the mobile phone to dial through speaking the example vocabularies. In the phase, the voice recognition apparatus of the mobile phone compares the speak contents of the user with the pronunciation of above-mentioned training, and chooses the optimum matching pronunciation before driving the mobile phone into action.

On the other hand, the user-independent voice recognition apparatus can prerecord the example vocabularies through the above-mentioned training phase as well, and the difference is that the user-independent training phase needs more people to speak the example vocabularies to the voice recognition apparatus, which even needs to be trained repeatedly. For example, in U.S. Pat. No. 6,735,563, a Dynamic Time Warping (DTW) engine is disclosed for being utilized as the recognition core of a user-independent voice recognition system. And for another example, in U.S. Pat. No. 6,671,668, a Hidden Markov Model (HMM) engine is disclosed for being utilized as the recognition core of user-independent voice recognition system.

The benefit of this system is that a user can use the apparatus directly without going through the training phase the way he does with a user-dependent voice recognition system. However, the user-independent voice recognition apparatus needs more system resource and more time for training, but even then, the optimum effect like the one achieved by the user-dependent voice recognition apparatus is hard to get.

### SUMMARY OF THE INVENTION

Accordingly, a scope of the invention is to provide a voice recognition system and method, and more particularly, the voice recognition system and method of the invention can select suitable voice model according to the position located. Therefore, the voice model can be specifically established for users at different positions, so as to raise the accuracy and efficiency of voice recognition and save the system resource.

According to the first preferred embodiment, a method for voice recognition comprises the following steps: first, obtaining a current position information through a global positioning system (GPS); afterwards, determining a current voice model from a plurality of candidate voice models according to the information of current position; and finally, performing voice recognition according to the current voice model.

According to the second preferred embodiment, a method for voice recognition comprises the following steps: first, obtaining a current network address information according to information obtained from the Internet; afterwards, determining a current voice model from a plurality of candidate voice models according to the current network address information; and finally, performing voice recognition according to the current voice model.

According to the second preferred embodiment, a voice recognition system comprises: a voice receiving apparatus, a positioning apparatus, a first memorizing apparatus, a second memorizing apparatus, and a processing apparatus.

Besides, the voice receiving apparatus can receive a user voice signal. The positioning apparatus is used for the applying of the information of current position from the voice receiving apparatus. The first memorizing apparatus is for storing a plurality of voice models. The second memorizing apparatus is for storing corresponding relationships between a plurality of position information and a plurality of voice models, and each of the plurality of position information corresponds to one of the plurality of voice models.

Furthermore, the processing apparatus sets one of the corresponded voice models of the first memorizing apparatus as a current voice model according to the current position information from the voice receiving apparatus, and the processing apparatus recognizes the user voice signal according to the current voice model.

The advantage and spirit of the invention may be understood by the following recitations together with the appended drawings.

### BRIEF DESCRIPTION OF THE APPENDED DRAWINGS

FIG. 1 is a function block diagram illustrating a voice recognition system according to a preferred embodiment of the invention.

FIG. 2A is a function block diagram illustrating a voice recognition system according to an embodiment of the invention.

FIG. 2B is a function block diagram illustrating a voice recognition system according to an embodiment of the invention.

FIG. 2C is a function block diagram illustrating a voice recognition system according to an embodiment of the invention.

FIG. 3 is a flow chart illustrating a voice recognition method according to a preferred embodiment of the invention.

FIG. 4 is a flow chart illustrating a voice recognition method according to an embodiment of the invention.

FIG. 5 is a flow chart illustrating a voice recognition method according to an embodiment of the invention.

### DETAILED DESCRIPTION OF THE INVENTION

The invention provides a voice recognition system and method. Several embodiments according to the invention are disclosed as follows.

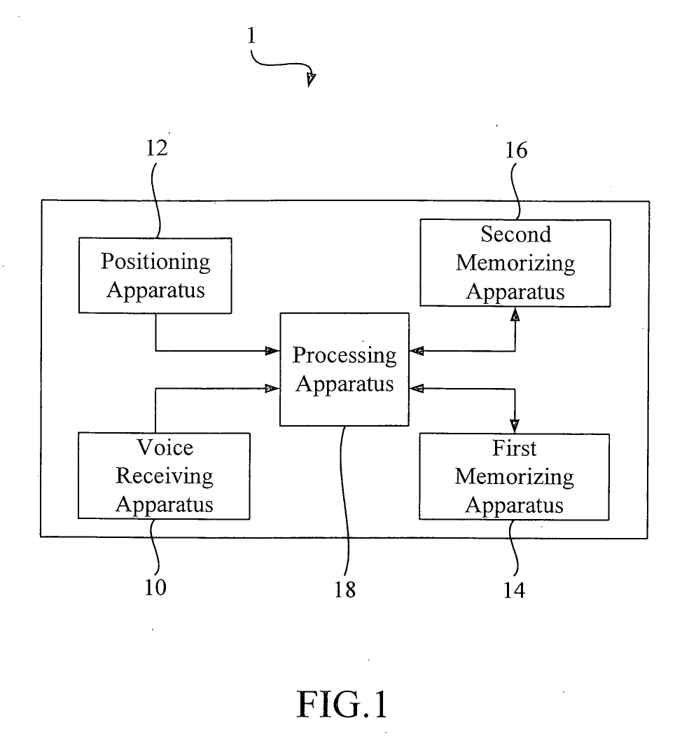

Please refer to FIG. 1. FIG. 1 is a function block diagram illustrating a voice recognition system according to a preferred embodiment of the invention. As shown in FIG. 1, the voice recognition system 1 comprises a voice receiving apparatus 10, a positioning apparatus 12, a first memorizing apparatus 14, a second memorizing apparatus 16, and a processing apparatus 18.

Furthermore, the voice receiving apparatus 10 can receive a user voice signal, and the positioning apparatus 12 is for providing a current position information of the voice receiving apparatus. The first memorizing apparatus 14 can store a plurality of voice models, and the second memorizing apparatus 16 can store corresponding relationships between a plurality of position information and the plurality of voice models, and each of the plurality position information corresponds to one of the plurality of voice models. Besides, the processing apparatus 18 sets one of the corresponded voice models of the first memorizing apparatus 14 as a current voice model according to the current position information from the voice receiving apparatus, and the processing apparatus 18 recognizes the user voice signal according to the current voice model.

In practice, the above-mentioned current position information of voice receiving apparatus can be a geographic position information, such as the current longitude and latitude, street, area, city, and country it is located. In practice, the current position information of voice receiving apparatus can also be a virtual position information, such as network address information.

In practice, the above-mentioned current model comprises such as HMM or other suitable voice models.

In an embodiment, the positioning apparatus 12 of the voice recognition system 1 of the invention can comprise a Global Positioning System (GPS) for sending and receiving apparatus. And the positioning apparatus 12 will move with the voice receiving apparatus 10 for obtaining the longitude and latitude coordinates of the current position of the voice receiving apparatus 10. Particularly, in this embodiment, the plurality of position information stored in the second memorizing apparatus 16 is a plurality of longitude and latitude coordinates, and each of the plurality of longitude and latitude coordinates corresponds to one of the plurality of voice models. Therefore, the processing apparatus 18 can use the longitude and latitude coordinates obtained by the positioning apparatus 12 to compare with the plurality of position information and the corresponding voice models. The processing apparatus obtains the corresponding voice model from the first memorizing apparatus 14 as the current voice model to perform voice recognition.

In an embodiment, the voice receiving apparatus 10 and the processing apparatus 18 of the voice recognition system 1 of the invention can be connected to a network through a wire or wireless function. Besides, the voice receiving apparatus 10 receives also information of the voice receiving apparatus from the Internet, such as information of an IP address or a domain name depending on where the voice receiving apparatus 10 is. The voice receiving apparatus 10 can transmit a plurality of network packets through the network to the processing apparatus 18, and each of the network packets has parts of the user voice signal and the network address information of the voice receiving apparatus. In this embodiment, the positioning apparatus 12 further comprises an analytic apparatus for analyzing the network address information of the voice receiving apparatus in the network packages. Particularly, the plurality of the position information stored in the second memorizing apparatus 16 are a plurality of network address information, and each of the plurality of network address information corresponds to one of the plurality of voice models. Therefore, the processing apparatus 18 can compare the plurality of position information and the corresponding voice model according to the network address information of the voice receiving apparatus analyzed by the analytic apparatus. The processing apparatus 18 obtains the corresponding voice model from the first memorizing apparatus 14 as the current voice model to perform voice recognition.

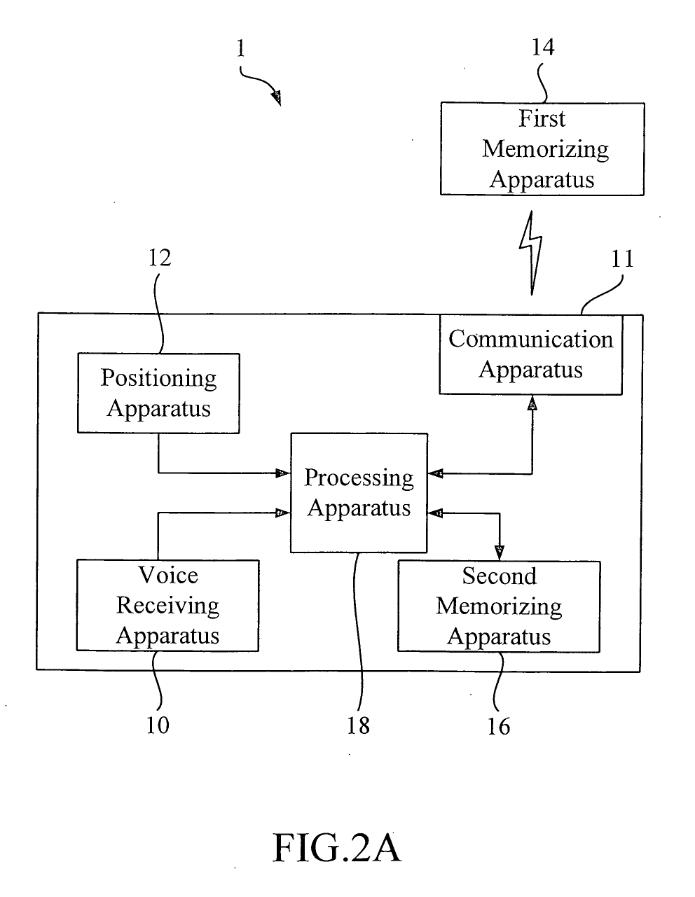

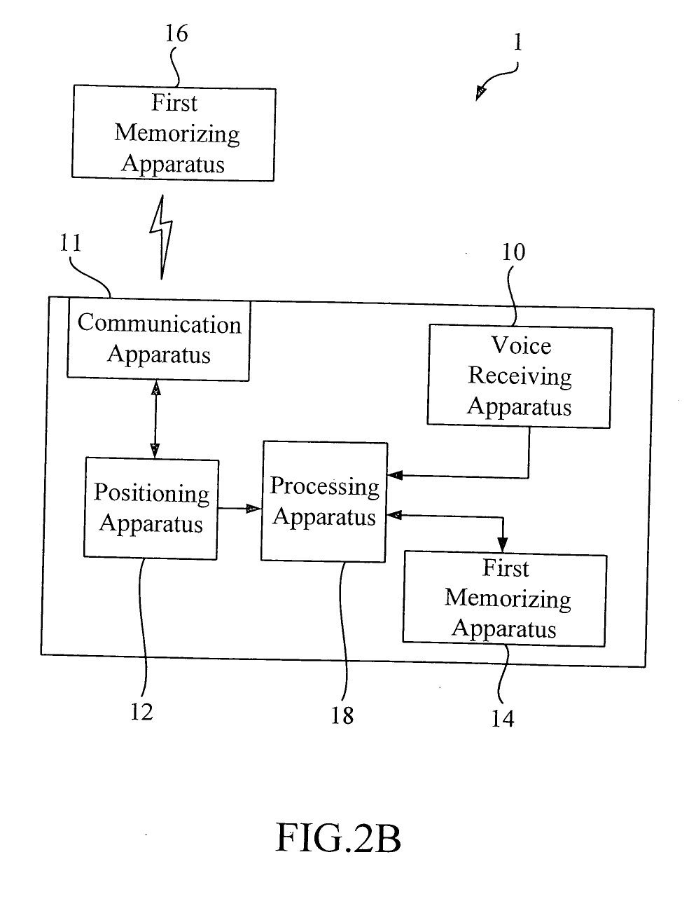

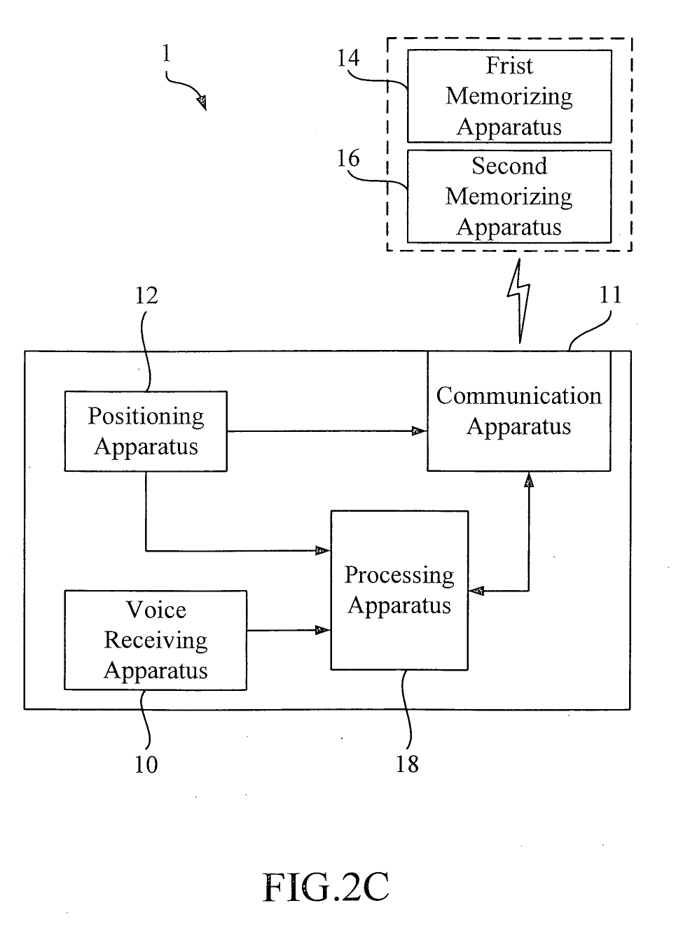

Please refer to FIG. 2A. FIG. 2A is a block diagram illustrating a voice recognition system I according to an embodiment of the invention. In this embodiment, the first memorizing apparatus 14 will not move with the voice receiving apparatus 10, and the processing apparatus 18 will move with the voice receiving apparatus 10. In other words, the voice receiving apparatus 10 and the processing apparatus 18 may be configured together when in transportation, such as on a train, an airplane, a car, a ship, and so on; or in portable electronic devices, such as a mobile phone, a camera, a walkman, a game player, and so on; or in other portable objects, such as mail, clothes, toy, and so on. And the first memorizing apparatus 14 may be configured in such a way as a server. Particularly, as shown in FIG. 2A, in this embodiment, the voice recognition system 1 further comprises a communication apparatus 11 for transmitting the current voice model between the processing apparatus 18 and the first memorizing apparatus 14. In practice, the communication apparatus 11 comprises a wireless transmission module, and the specification thereof may individually or simultaneously comply with the specifications of IEEE 802.11, 3G, and WiMax.

Please refer to FIG. 2B. FIG. 2B is a function block diagram illustrating a voice recognition system 1 according to another embodiment of the invention. In this embodiment, the second memorizing apparatus 16 will not move with the voice receiving apparatus 10, and the positioning apparatus 12 will move with the voice receiving apparatus 10. In other words, the positioning apparatus 12 and the voice receiving apparatus 10 may be configured together when in transportation, portable electronic devices, or other portable objects, and the second memorizing apparatus 16 may be configured as a server in such cases. Particularly, in this embodiment, the voice recognition system 1 further comprises a communication apparatus 11 for transmitting the current position information of the voice receiving apparatus between the positioning apparatus 12 and the second memorizing apparatus 16. In practice, the communication apparatus similarly comprises a wireless transmission module, and the specification may individually or simultaneously comply with the specifications of IEEE 802.11, 3G, and WiMax.

Please refer to FIG. 2C. FIG. 2C is a function block diagram illustrating a voice recognition system 1 according to another embodiment of the invention. In this embodiment, the first memorizing apparatus 14 and the second memorizing apparatus 16 of the invention will not move with the voice receiving apparatus 10, and the positioning apparatus 12 and the processing apparatus 18 will move with the voice receiving apparatus 10. In other words, the positioning apparatus 12 and the voice receiving apparatus 10 may be configured together when in transportation, portable electronic devices, or other portable objects, and the second memorizing apparatus 16 may be configured in such a way as a server. Particularly, in this embodiment, the voice recognition system 1 further comprises a communication apparatus 11. The communication apparatus 11 can transmit the current voice model between the processing apparatus 18 and the first memorizing apparatus 14, and can transmit the current position information of the voice receiving apparatus between the positioning apparatus 12 and the second memorizing apparatus 16 at the same time.

In an embodiment, the voice receiving apparatus 10, the positioning apparatus 12, the processing apparatus 18, and the communication apparatus 11 of the voice recognition system 1 of the invention are configured in a transnational train, and the first memorizing apparatus 14 and the second memorizing apparatus 16 are configured in a server of a control center.

When a train travels in the territory of country A, the positioning apparatus 12 can obtain the position information, such as the longitude and latitude (through, such as GPS), area/city (through, such as identification signal transmission apparatus of the station of country A), and so on, of the position where the voice receiving apparatus 10 is located to be the current position information of the voice receiving apparatus. The processing apparatus 18 communicates with the server through the communication apparatus 11, and compares the current position information of the voice receiving apparatus with the plurality of information stored in the second memorizing apparatus 16, and regards the corresponding voice model of the matching position information as the current voice model (such as a voice model developed according to the inhabitants' speech of the area/country/city representative of the position information). Furthermore, the processing apparatus 18 downloads the current voice model from the first memorizing apparatus 14 of the server through the communication apparatus 11, and performs voice recognition for the user voice signal received by the voice receiving apparatus 10 through the current voice model. For example, the people of country A can give voice orders, such as open the door, close the door, notify the head of the train crew, and so on, to the voice receiving apparatus 10 in the train, and the processing apparatus 18 can perform voice recognition through a voice model developed according to the speech of the people of country A, so as to raise accuracy of voice recognition.

Similarly, when the train travels across the national borders between country A and country B and enters country B, the positioning apparatus 12 can obtain the position information, such as the longitude and latitude (through, such as GPS), country (through, such as identification signal transmission apparatus at the station of country B or at the national boundary of country B), and so on, of the position where the voice receiving apparatus 10 is to be the current position information of the voice receiving apparatus. The processing apparatus 18 communicates with the server through the communication apparatus 11, and compares the current position information of the voice receiving apparatus with the plurality of information stored in the second memorizing apparatus 16, and regards the corresponding voice model of the matching position information as the current voice model (such as a voice model developed according to the speech of the people of country B). Furthermore, the processing apparatus 18 downloads the current voice model from the first memorizing apparatus 14 of the server through the communication apparatus 11, and performs voice recognition for the user voice signal received by the voice receiving apparatus 10 through the current voice model. Accordingly, the processing apparatus 18 can perform voice recognition through a voice model developed according to the speech of the people of country B, so as to raise accuracy of voice recognition.

In another embodiment, the voice receiving apparatus 10, the positioning apparatus 12, the processing apparatus 18, and the communication apparatus 11 of the voice recognition system 1 of the invention are configured in mail packages mailed across countries, and the first memorizing apparatus 14 and the second apparatus 16 are configured in a server of a control center. Besides, in this embodiment, the voice recognition system 1 further comprises a warning apparatus and a third memorizing apparatus, and the apparatuses are similarly configured in the mail package.

When a plurality of the above-mentioned mail packages are mailed from country A to country B, the voice recognition system 1 of the invention can download suitable voice model from the server of the control center (such as a voice model can be developed by the post office staff of country C) as the current voice model to recognize the voice signals of the post office staff of country C. For example, when the post office staff of country C deal with the mail packages, they can give voice orders, such as “urgent dispatch,” “forward to country D,” “postal delivery zone number 12345,” and so on; and at this moment, the processing apparatus 18 in the mail package recognizes the voice signals according to the current voice model, and compares the voice signals with a plurality of delivering information pre-stored in the third memorizing apparatus. If the voice signals match one of the plurality of delivering information pre-stored in the third memorizing apparatus, the processing apparatus 18 drives the warning apparatus to send a warning signal, such as voice or light, to assist the post office staff of country C to quickly obtain and deal with the matching mail packages.

Obviously, in this embodiment, in addition to raise accuracy for voice recognition, the voice recognition system 1 of the invention can increase efficiency for the post office staff of country C to deal with mails.

In another embodiment, the voice receiving apparatus 10, the positioning apparatus 12, the processing apparatus 18, and the communication apparatus 11 of the voice recognition system 1 of the invention are configured in transnational trade articles, such as trade articles with voice recognition function, like toys, mobile phones, PDAs, and so on. When the trade articles are sold respectively in country D and country E, after buying, the user of country D can download suitable voice model from the server in country D preset by the manufacturer through the communication apparatus 11 in the trade articles, to be used as the current voice model for the processing apparatus 18 to perform voice recognition. Similarly, after buying, the user of country E can download suitable voice model, from the server in country E preset by the manufacturer through the communication apparatus 11 in the trade articles, to be used as the current voice model for the processing apparatus 18 to perform voice recognition.

Accordingly, the manufacturer does not need to pre-store voice model according to the sale area/country at the manufacturing stage. The cost can therefore be decreased and the flexibility for product management can be increased.

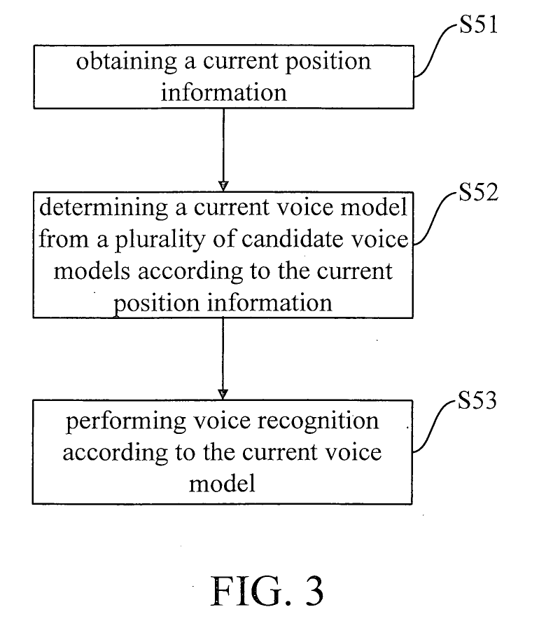

Please refer to FIG. 3. FIG. 3 is a flow chart illustrating a voice recognition method according to a preferred embodiment of the invention. As shown in FIG. 3, the method comprises the following steps: firstly, in step S51, obtaining a current position information; afterwards, in step S52, determining a current voice model from a plurality of candidate voice models according to the current position information; and finally, in step S53, performing voice recognition according to the current voice model.

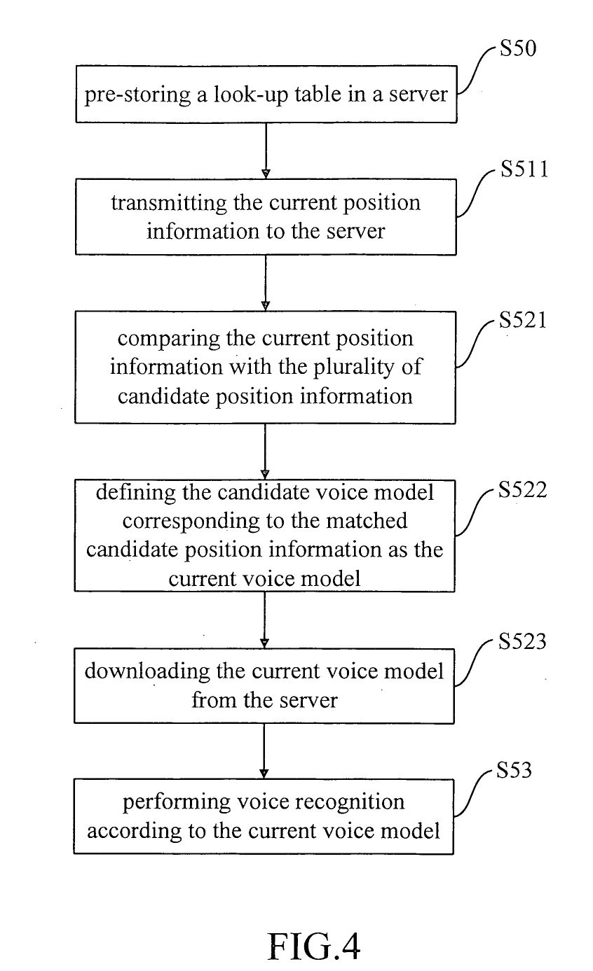

Please refer to FIG. 4. FIG. 4 is a flow chart illustrating a voice recognition method according to an embodiment of the invention. As shown in FIG. 4, the method can further comprise the following steps: firstly, in step S50, pre-storing a look-up table in a server, the look-up table comprising a plurality of candidate position information, and each of the plurality of candidate position information corresponding to one of the plurality of candidate voice models; afterwards, in step S511, transmitting the current position information to the server; and then, in step S521, comparing the current position information with the plurality of candidate position information; and when one of the candidate position information is matched with the current position information, in step S522, defining the candidate voice model corresponding to the matched candidate position information as the current voice model; finally, in step S523, downloading the current voice model from the server.

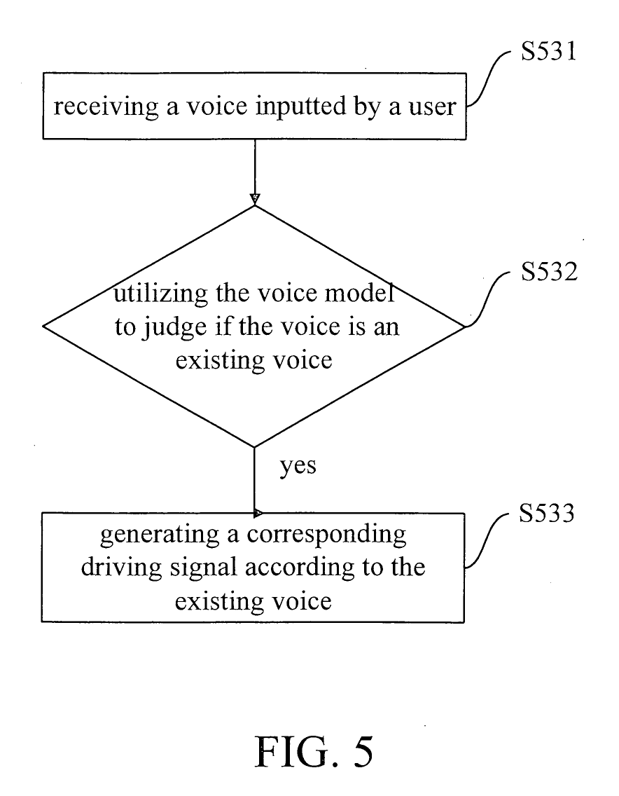

Please refer to FIG. 5. FIG. 5 is a flow chart illustrating a voice recognition method according to an embodiment of the invention. As shown in FIG. 5, the method can further comprise the following steps: firstly, in step S531, receiving a voice inputted by a user; afterwards; then, in step S532, utilizing the voice model to judge if the voice is an existing voice; and if yes, in step S533, generating a corresponding driving signal according to the existing voice.

In a preferred embodiment, the above-mentioned current position information can be obtained through GPS. In other words, the current position information is a geographic position information, and the geographic position information can comprise longitude and latitude coordinates information. In practice, the current position information can be obtained through other ways, such as identification signals sent from a bus station, a train station, an airport, and so on, or other suitable ways.

Besides, in another preferred embodiment, the above-mentioned position information can be obtained from the computer network address information, such as Internet Protocol (IP) address information, domain name information, and so on.

In this preferred embodiment, the method comprises the following steps: firstly, obtaining the current position information according to the network address information; afterwards, obtaining a corresponding voice model according to the current position information; and finally, performing voice recognition according to the current voice model.

In practice, when the current position information is obtained from a network address information, the method of the invention comprises the following steps: first, pre-storing a first look-up table comprising a plurality of candidate network address information, and each of the plurality of candidate network address information corresponding to one of a plurality of position information.

The device performing following steps: obtaining the network address information; comparing the network address information with the plurality of candidate network address information stored in the look-up table; and when one of the candidate network address information is matched with the network address information, defining the position information corresponding to the matched candidate network address information as the current voice model.

In practice, when the current position information is obtained from an Internet Protocol (IP) address information, the method of the invention further comprises the following steps: first, pre-storing a first look-up table, the first look-up table comprising a plurality of network address information, and each of the plurality of network address information corresponding to a one of the plurality of candidate voice models; afterwards, transmitting the current address information to the server; and then, comparing the current network address information with the plurality of candidate network address information ; and when one of the candidate network address information is matched with the current network address information, defining the voice model corresponding to the matched network address information as the current voice model; finally, downloading the current voice model from the server.

From what was mentioned above, according to the voice recognition system and the methods of the invention, the suitable voice model can be selected according to location, and therefore, a specific voice model can be established according to different users at different locations to raise the accuracy and efficiency of voice recognition. On the other hand, the manufacturing cost can be decreased efficiently according to the voice recognition system and the methods of the invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for performing voice recognition, comprising the following steps:
obtaining a current position information;
determining a current voice model from a plurality of candidate voice models according to the current position information; and
performing voice recognition according to the current voice model.

2. The method of claim 1, wherein the current position information is geographic position information obtained through a global positioning system (GPS).

3. The method of claim 1, wherein the current position information is obtained through an identification signals sent from one selected from the group consisting of a bus station, a train station, and an airport.

4. The method of claim 1, wherein the current voice model comprises a Hidden Markov Model (HMM).

5. The method of claim 1, wherein the step for determining the current voice model according to the current position information comprising the following steps:
(a) pre-storing a look-up table, the look-up table comprising a plurality of candidate position information, and each of the plurality of candidate position information corresponding to one of the plurality of candidate voice models;
(b) comparing the current position information with the plurality of candidate position information; and
(c) when one of the candidate position information is matched with the current position information, defining the candidate voice model corresponding to the matched candidate position information as the current voice model.

6. The method of claim 5, further comprises the following steps:
saving the look-up table in a server;
transmitting the current position information to the sever;
performing the steps (b) and (c) in the server; and
downloading the current voice model from the server.

7. The method of claim 1, wherein the step for performing voice recognition according to the current voice model further comprises the following steps:
receiving a voice inputted by a user; and
utilizing the voice model to judge if the voice is an existing voice, and if yes, generating a corresponding driving signal according to the existing voice.

8. A method for performing voice recognition, comprising the following steps:
obtaining a current network address information;
determining a current voice model from a plurality of candidate voice models according to the current network address information; and
performing voice recognition according to the current voice model.

9. The method of claim 8, wherein the step for determining the current voice model according to the current network address information comprises the following steps:
(a) pre-storing a first look-up table, the first look-up table comprising a plurality of network address information, and each of the plurality of network address information corresponding to a one of the plurality of candidate voice models;
(b) comparing the current network address information with the plurality of candidate network address information; and
(c) when one of the candidate network address information is matched with the current network address information, defining the voice model corresponding to the matched network address information as the current voice model.

10. The method of claim 9, further comprising the following step:
saving the first look-up table in a server;
transmitting the current network address information to the sever;
performing the steps (b) and (c) in the server; and
downloading the current voice model from the server.

11. The method of claim 8, wherein the network address information is an IP address information or a domain name information.

12. A voice recognition system, comprising:
a voice receiving apparatus, for receiving a user voice signal;
a positioning apparatus, for providing a current position information of the voice receiving apparatus;
a first memorizing apparatus, for storing a plurality of voice models;
a second memorizing apparatus, for storing corresponding relationships between a plurality of position information and the plurality of voice models, with each of the plurality of position information corresponding to one of the plurality of voice models; and
a processing apparatus, for setting one of the corresponded voice models of the first memorizing apparatus as a current voice model according to the current position information of the voice receiving apparatus, and the processing apparatus recognizing the user voice signal according to the current voice model.

13. The voice recognition system of claim 12, wherein the positioning apparatus further comprises:
a GPS sending and receiving apparatus, and the positioning apparatus moving with the voice receiving apparatus for obtaining longitude and latitude coordinates of the current position of the voice receiving apparatus;
wherein the plurality of position information stored in the second memorizing apparatus are a plurality of longitude and latitude coordinates, and each of the plurality of longitude and latitude coordinates corresponding to one of the plurality of voice models.

14. The voice recognition system of claim 12, wherein the voice receiving apparatus and the processing apparatus are connected to a network, and the voice receiving apparatus having an network address information of the voice receiving apparatus, the voice receiving apparatus transmitting a plurality of network packets to the processing apparatus through the network, and each of the plurality of network packets having parts of the user voice signal and the network address information of the voice receiving apparatus, the positioning apparatus further comprising:
an analytic apparatus, for analyzing the network address information of the voice receiving apparatus in the network packets;
wherein the plurality of the position information stored in the second memorizing apparatus are a plurality of network address information, and each of the network address information corresponding to one of the plurality of voice models.

15. The voice recognition system of claim 14, wherein the network address information of the voice receiving apparatus is an IP address information or a domain name information of the voice receiving apparatus.

16. The voice recognition system of claim 12, wherein the first memorizing apparatus not moving with the voice receiving apparatus, and the processing apparatus moving with the voice receiving apparatus, wherein the voice recognition system further comprises:
a communication apparatus, for transmitting the current voice model between the processing apparatus and the first memorizing apparatus.

17. The voice recognition system of claim 16, wherein the communication apparatus comprises a wireless transmission module containing at least a specification selected from the group consisting of IEEE 802.11, 3G, and WiMax.

18. The voice recognition system of claim 12, wherein the second memorizing apparatus moving not with the voice receiving apparatus, and the positioning apparatus moving with the voice receiving apparatus, wherein the voice recognition system further comprises:
a communication apparatus, for transmitting the current position information of the voice receiving apparatus between the positioning apparatus and the second memorizing apparatus.

19. The voice recognition system of claim 18, wherein the communication apparatus comprises a wireless transmission module containing at least a specification selected from the group consisting of IEEE 802.11, 3G, and WiMax.

20. The voice recognition system of claim 12, wherein the current position information is a geographic position information.
